(19) United States
(12) Patent Application Publication
(10) Pub. No.: US 2026/0257743 A1
(43) Pub. Date: Sep. 3, 2026

(54) A STORAGE COMPARTMENT FOR A VEHICLE

(71) Applicant: TVS MOTOR COMPANY LIMITED, Chennai (IN)

(72) Inventors: Rengarajan Babu, Chennai (IN); Manish Garg, Chennai (IN); Yogesh Chandrakant Kotnis, Chennai (IN); Burra Tirumala Srikar, Chennai (IN)

(73) Assignee: TVS MOTOR COMPANY LIMITED, Chennai (IN)

(21) Appl. No.: 18/718,430

(22) PCT Filed: Aug. 30, 2022
(86) PCT No.: PCT/IN2022/050771

§ 371 Date: Jun. 10, 2024

(30) Foreign Application Priority Data
Dec. 10, 2021 (IN) 202141057619

(51) Int. Cl. B62J 9/14; B62J 41/00; B62J 45/00; B62J 45/41; F28D 21/00

(52) U.S. Cl. CPC B62J 9/14; B62J 41/00; B62J 45/00; B62J 45/41; F28D 21/00; F28D 2021/008

(57) ABSTRACT

A storage compartment for a vehicle includes a base. A plurality of walls extends from the base to define a storage space for storing one or more articles. One or more cooling devices are disposed inside the storage space. The one or more cooling devices are configured to be received on the one or more walls of the storage compartment.

### FIELD OF THE INVENTION

The present invention relates to a storage compartment for a vehicle. More particularly, the present invention relates to a storage compartment having one or more cooling devices.

### BACKGROUND OF THE INVENTION

In vehicles, one or more storage compartments are generally provided for placing one or more articles. The one or more articles can be helmets, perishable items such as food items, electronic items such as laptops, mobile phones, mobile chargers, and the likes. In a vehicle, storage compartments can also be provided at various locations. In a non-limiting example, in a straddle type vehicle, a storage compartment is provided below a seat. In another non-limiting example, in a straddle type vehicle, a storage compartment may be located in an area between a floor of the vehicle on which a rider places his feet and a handlebar of the vehicle. In another non-limiting example, one or more storage compartments are provided in a console assembly provided within the interior of a car.

The storage compartments of the vehicles are generally made of polymers. Due to light weight of the polymers and growth in polymer manufacturing technologies, storage compartments can be made in various different shapes and sizes. However, the mechanical properties of the polymers are temperature dependent. For storage compartments located near the engine, during the vehicle riding condition, the storage compartment may get heated up due to the heat radiated by the engine. The storage compartments of the vehicles may also get heated in extremely hot weather and climatic conditions. This leads to decrease in the strength of the storage compartment over a period of time/usage. Moreover, articles such as food items, perishable items, electronic devices etc. are temperature sensitive and can be adversely affected by heating of the storage compartments. Also, polymers may undergo chemical changes on being heated to a certain maximum temperature and eject harmful fumes. This can be detrimental to the articles placed in the storage compartment. In one non-limiting example, food articles stored in the storage compartment may be exposed to harmful fumes which renders it unfit for human consumption.

Also, the storage compartments provided in the vehicles, especially two-wheelers or three-wheelers, have limited space. Therefore, any device to maintain the temperature of the storage compartment or of the articles stored in the storage compartment should not take much storage space in the storage compartment.

In view of the foregoing, there is a need to provide storage compartments in a vehicle which overcome the above-mentioned disadvantages.

### SUMMARY OF THE INVENTION

In one aspect, a storage compartment for a vehicle having at least one cooling device is disclosed. The storage compartment has a base and a plurality of walls extend from the base to define a storage space for storing one or more articles. One or more cooling devices are disposed inside the storage space. The one or more cooling devices are configured to be received on the one or more walls of the storage compartment.

In an embodiment, the storage compartment further comprises a lid which covers the storage space of the storage compartment.

In an embodiment, at least one of the walls which receives the one or more cooling devices has one or more first cut out portions to receive the one or more cooling devices. The one or more cooling devices generally have wiring harness which is received in the one or more first cut out portions in the walls.

In an embodiment, each cooling device comprises at least one front plate and at least one rear plate. The rear plate is positioned opposite the front plate. The rear plate of the cooling device is a hot plate and the front plate of the cooling device is a cold plate. The cooling device is mounted on the wall such that rear plate faces the wall and the front plate faces the storage space.

In an embodiment, the one or more walls on which the one or more cooling devices are mounted/received comprises one or more second cut out portions for dissipating heat of the rear plates of the cooling devices into external environment.

In an embodiment, one or more heat exchangers are operatively connected to the rear plates of the one or more cooling devices for dissipating the heat of the cooling device into the external environment. In one non limiting example, the heat exchanger is placed below the seat, preferably near the rear portion of the vehicle, for dissipating heat of the rear plate of the cooling device into the external environment.

In an embodiment, an article holding device is placed inside the storage compartment. The article holding device is connected to the one or more walls of the storage compartment such that at least one surface of one or more articles stored in the article holding device is in contact with the front plate/cold plate of the one or more cooling devices.

In an embodiment, the storage space in the storage compartment may be divided into one or more compartments. One or more partition walls may be used to divide the storage space into at least a primary storage compartment and a secondary storage compartment wherein the secondary storage compartment has the one or more cooling devices. In such an arrangement, the articles which are sensitive to temperature variations such as perishable food items or electronic devices can be kept in the secondary storage compartment and the article which are not sensitive to the temperature variations such as helmets can be kept in the primary storage compartment.

In an embodiment, the one or more cooling devices are switched ON when the vehicle is running and the one or more cooling devices are switched OFF when the vehicle is not running. In one non-limiting example, the cooling device is in communication with an Electronic Control Unit (ECU) which controls the operation of the cooling device in vehicle running and non-running condition.

In an embodiment, the at least one cooling device is in communication with the ignition key unit and is capable of being switched ON when the vehicle is not running.

In an embodiment, the storage compartment comprises one or more weight sensors disposed inside the storage space of the compartment. The one or more weight sensors detect the weight of the one or more articles to be cooled in the storage compartment. The weight sensor is in communication with the one or more cooling devices. Based on the weight detected by the one or more weight sensors, the one or more cooling devices are operated. In case the weight of the one or more articles detected by the weight sensor exceeds a pre-determined value, the cooling device is switched ON.

In another aspect of the invention, a straddle type vehicle having a storage compartment is disclosed. The straddle type vehicle has a seat on which an occupant sits. The article storage compartment is positioned beneath the seat. The article storage compartment of the straddle type vehicle comprises a base and a plurality of walls extending from the base in a vehicle upward direction to define a storage space. The storage space comprises one or more cooling devices. The one or more walls are configured to receive the one or more cooling devices.

In an embodiment, at least one of the walls which receives the one or more cooling devices has one or more first cut out portions to receive the one or more cooling devices. The one or more cooling devices generally have wiring harness which is received in the one or more first cut out portions in the walls.

In an embodiment, each cooling device comprises at least one front plate and at least one rear plate. The rear plate is positioned opposite the front plate. The rear plate of the cooling device is a hot plate and the front plate of the cooling device is a cold plate. The cooling device is mounted on the wall such that rear plate faces the wall and the front plate faces the storage space.

In an embodiment, the one or more walls on which the one or more cooling devices are mounted/received comprises one or more second cut out portions for dissipating heat of the rear plates of the cooling devices into external environment.

In an embodiment, one or more heat exchangers are operatively connected to the rear plates of the one or more cooling devices for dissipating the heat of the cooling device into the external environment. In one non limiting example, the heat exchanger is placed below the seat, preferably near the rear portion of the vehicle, for dissipating heat of the rear plate of the cooling device into the external environment.

In an embodiment, an article holding device is placed inside the storage compartment. The article holding device is connected to the one or more walls of the storage compartment such that at least one surface of one or more articles stored in the article holding device is in contact with the front plate/cold plate of the one or more cooling devices.

In an embodiment, the storage space in the storage compartment may be divided into one or more compartments. One or more partition walls may be used to divide the storage space into at least a primary storage compartment and a secondary storage compartment wherein the secondary storage compartment has the one or more cooling devices. In such an arrangement, the articles which are sensitive to temperature variations such as perishable food items or electronic devices can be kept in the secondary storage compartment and the article which are not sensitive to the temperature variations such as helmets can be kept in the primary storage compartment.

In an embodiment, the one or more cooling devices are switched ON when the vehicle is running and the one or more cooling devices are switched OFF when the vehicle is not running. In one non-limiting example, the cooling device is in communication with an Electronic Control Unit (ECU) which controls the operation of the cooling device in vehicle running and non-running condition.

In an embodiment, the at least one cooling device is in communication with the ignition key unit and is capable of being switched ON when the vehicle is not running.

In an embodiment, the storage compartment comprises one or more weight sensors disposed inside the storage space of the compartment. The one or more weight sensors detect the weight of the one or more articles to be cooled in the storage compartment. The weight sensor is in communication with the one or more cooling devices. Based on the weight detected by the one or more weight sensors, the one or more cooling devices are operated. In case the weight of the one or more articles detected by the weight sensor exceeds a pre-determined value, the cooling device is switched ON.

To further clarify the advantages and features of the present invention, a more particular description of the invention will be rendered by reference to specific embodiments thereof, which is illustrated in the appended Figures. It is appreciated that these figures depict only typical embodiments of the invention and are therefore not to be considered limiting of its scope. The invention will be described and explained with additional specificity and detail with the accompanying figures.

### BRIEF DESCRIPTION OF THE DRAWINGS

Reference will be made to embodiments of the invention, examples of which may be illustrated in accompanying figures. These figures are intended to be illustrative, not limiting. Although the invention is generally described in context of these embodiments, it should be understood that it is not intended to limit the scope of the invention to these particular embodiments.

FIG. 1 illustrates a perspective view of a storage compartment, in accordance with an embodiment of the present invention.

FIG. 2 is a magnified view of the wall configured for receiving the one or more cooling devices, in accordance with an embodiment of the present invention.

FIG. 3 is a perspective view of the cooling device, in accordance with an embodiment of the present invention.

FIGS. 4a and 4b are the magnified view of the wall with a cooling device, in accordance with an embodiment of the present invention.

FIG. 5 illustrates a perspective view of the storage compartment with cooling devices and an article holding device, in accordance with an embodiment of the present invention.

FIG. 6 illustrates a perspective view of the storage compartment, depicting an article placed in the article holding device in accordance with an embodiment of the present invention.

FIG. 7 illustrates a perspective view of a straddle type vehicle having a storage compartment, in accordance with the embodiments of the present invention.

### DETAILED DESCRIPTION OF THE INVENTION

Various features and embodiments of the present invention here will be discernible from the following further description thereof, set out hereunder.

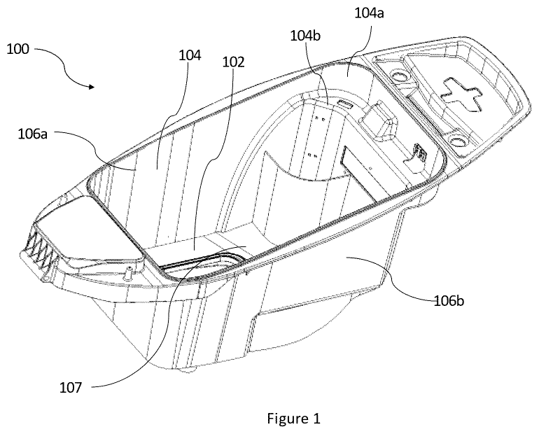

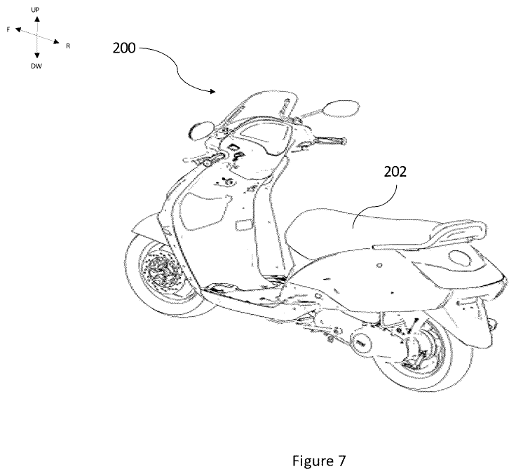

FIG. 1 illustrates a perspective view of a storage compartment 100, in accordance with an embodiment of the present invention. It is to be understood that shape, size, and orientation of the storage compartment 100 in FIG. 1 is only for the purpose of illustration and should not be construed as limiting. Based on the type of vehicle and location of the storage compartment in the vehicle, the storage compartment can be of different shapes, size, and orientations. In one non-limiting example, the vehicle used may be a straddle type vehicle 200 as shown in FIG. 7, or may be a step through vehicle. The storage compartment 100 may be located below the seat 202 of the vehicle 200, enclosed between the different body panels of the vehicle 200.

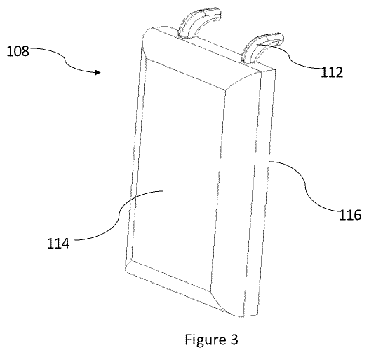

As shown, the storage compartment 100 comprises a base 102 and a plurality of walls 104 extending from the base 102. Each of the plurality of the walls 104 has an inner surface 106a and an outer surface 106b. The inner surfaces 106a of the walls 104 define a storage space 107. The storage space 107 can accommodate one or more articles (not shown). One or more inner surfaces 106a of the plurality of walls 104 are configured to receive the one or more cooling devices 108 (Refer to FIG. 3) .

In an embodiment, the one or more walls 104 of the storage compartment 100 can be divided into primary walls 104a and secondary walls 104b. The primary walls 104a are the walls which extend from the periphery of the base 102 and the secondary walls 104b are the walls which extend/project from one or more primary walls 104a in a direction towards the storage space 107. Both the primary walls 104a as well as secondary walls 104b can be configured to receive one or more cooling devices 108 (Refer to FIG. 3).

In an embodiment, the secondary walls 104b may be hollow walls which are configured to receive/house one or more components of the cooling devices 108 (Refer to FIG. 3) such as cooling circuits and/or one or more heat exchangers for dissipating heat of the one or more cooling devices 108 (Refer to FIG. 3) to external environment. The term external environment in the context of the present invention means the atmosphere or environment outside the vehicle.

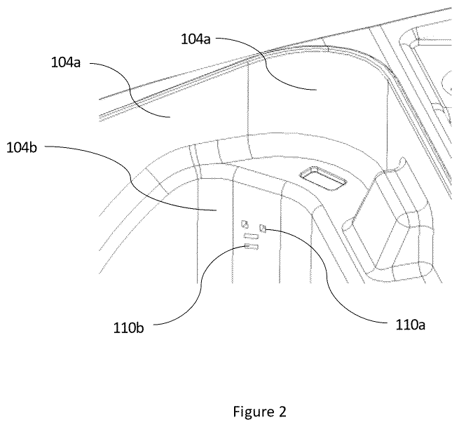

FIG. 2 is a magnified view of the wall 104b configured for receiving the one or more cooling devices 108, in accordance with an embodiment of the present invention.

As shown, the wall 104b configured for receiving the one or more cooling devices 108 (Refer to FIG. 3) comprises one or more first cut-out portions 110a. It is to be understood that both the primary walls 104a and/or secondary walls 104b are configured to receive one or more cooling devices 108 (Refer to FIG. 3). The one or more first cut out portions 110a receive a wiring harness (not shown) of the one or more cooling devices 108 (Refer To FIG. 3).

In an embodiment, the primary wall 104a and/or secondary wall 104b further comprises one or more second cut out portions 110b. The one or more second cut out portions 110b are used to dissipate the heat of the one or more cooling devices 108 (Refer to FIG. 3) into external environment.

In an embodiment, the one or more second cut out portions 110b are used to operatively connect the one or more cooling devices 108 (Refer to FIG. 3) with one or more heat exchangers for dissipating the heat of the cooling devices 108 (Refer to FIG. 3) into external environment. In one non limiting example, the one or more heat exchangers are placed below a seat of the vehicle, preferably near a rear portion of the vehicle, for dissipating heat of the one or more cooling devices 108 (Refer to FIG. 3) into external environment.

FIG. 3 is a perspective view of the cooling device 108, in accordance with an embodiment of the present invention.

As shown, the cooling device 108 comprises at least one front plate 114 and at least one rear plate 116. The rear plate 116 is positioned opposite the front plate 114. The front plate 114 is a cold plate and the rear plate 116 is a hot plate. The cooling device 108 has a wiring harness 112. The cooling device 108 also has a cooling circuit (not shown) which operates the cooling device 108. It is to be understood that the shape of the cooling device 108 as shown in FIG. 3 is only for illustration purposes and should not be construed as limiting. The cooling devices 108 can be of any shape, size, and orientation as per the design requirements of the storage compartments. In one non-limiting example, the cooling device 108 is cylindrical in shape. In another non-limiting example, the cooling device 108 is flat shaped. In yet another non-limiting example, the cooling device 108 is spherical in shape.

In an embodiment, the cooling device 108 is in communication with an Electronic Control Unit (ECU) of the vehicle.

In an embodiment, the one or more cooling devices 108 are switched ON when the vehicle is running and switched OFF when the vehicle is not running. This embodiment will prevent excessive power consumption. The state of the vehicle i.e. running or non-running is transmitted to the cooling circuit of the cooling device 108 by the Electronic Control Unit (ECU).

In an embodiment, the one or more cooling devices 108 are in communication with an ignition key unit and can be switched ON when the vehicle is not running.

In an embodiment, one or more weight sensors are located in the storage compartment 100 which are capable of detecting weight of one or more articles to be cooled in the storage compartment 100. The one or more weight sensors are in communication with the Electronic Control Unit (ECU). The Electronic Control Unit (ECU) compares the detected weight with a pre-determined weight (already stored in the storage memory of the Electronic Control Unit (ECU)) and operates the one or more cooling devices 108. In a non-limiting example, the one or more cooling devices 108 are switched ON if the detected weight exceeds the pre-determined weight.

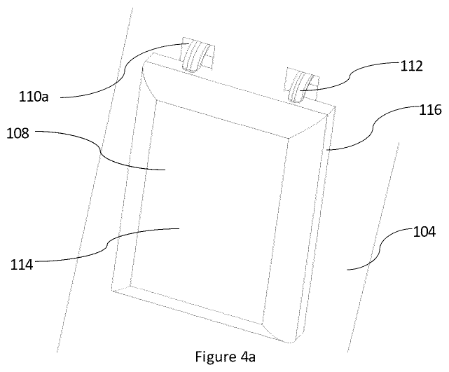

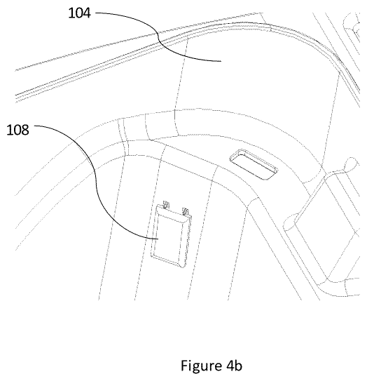

FIGS. 4a and 4b are the magnified view of the wall 104 with a cooling device 108, in accordance with an embodiment of the present invention.

As shown, the wall 104 has one or more first cut out portions 110a which receives the wiring harness 112 of the cooling device 108. The rear plate/hot plate 116 of the cooling device 108 faces the wall 104 and the front plate/cold plate 114 of the cooling device 108 faces the storage space of the storage compartment 100. It is to be noted that the second cut out portions (not shown) discussed in the preceding paragraphs dissipate the heat of the rear plate/hot plate 116 of the one or more cooling device 108 into the external environment. Also, the one or more cooling devices 108 are operatively connected to the one or more heat exchangers for dissipating the heat of the rear plate/hot plate 116 of the one or more cooling devices 108.

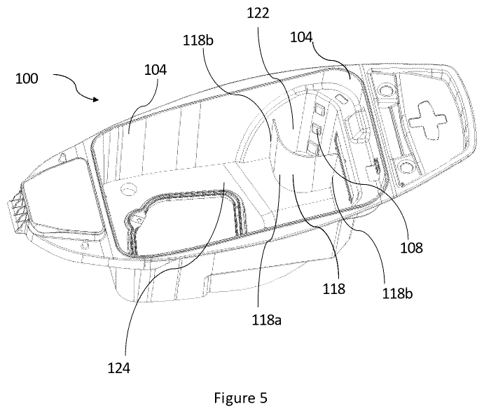

FIG. 5 illustrates a perspective view of the storage compartment 100 with cooling devices 108 and an article holding device 118, in accordance with an embodiment of the present invention.

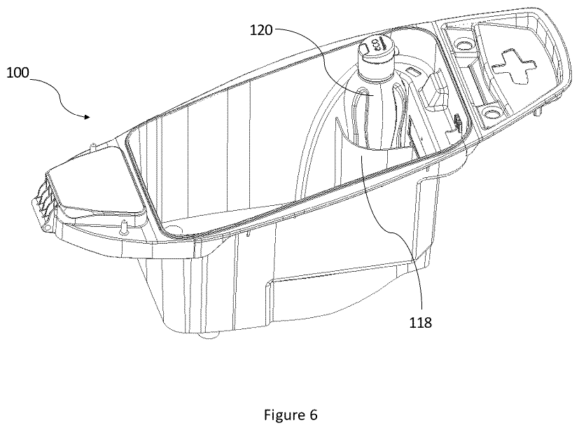

As shown, the cooling devices 108 are received on the wall 104 of the storage compartment 100. Also, an article holding device 118 is provided in the storage compartment 100 to hold one or more articles 120 (Refer to FIG. 6) . The article holding device 118 as shown in FIG. 5 is for the purposes of illustration and should not be construed as limiting. The shape, size and orientation of the article holding device 118 shall depend on the shape, size, and orientation of the storage compartment and also on the shape, size, and orientation of the article to be held in the article holding device 118.

The article holding device 118 has a body portion 118a extending between two ends 118b. The ends 118b of the article holding device 118 are connected to one or more walls 104 of the storage compartment 100.

In an embodiment, the storage compartment 100 may also be divided into a plurality of storage compartments 122, 124 wherein at least one of the compartments has one or more cooling devices 108. In a non-limiting example, one or more partition walls are provided to divide the storage compartment into at least a primary storage compartment 122 and a secondary storage compartment 124. The primary storage compartment 122 is surrounded by walls having no cooling devices 108. The secondary storage compartment 124 is surrounded by walls having one or more cooling devices 108. In a non-limiting example, articles such as helmets are present in the primary storage compartment 122. In a non-limiting example, articles such as perishable food items are placed in the secondary storage compartment 124.

FIG. 6 illustrates a perspective view of the storage compartment 100, depicting an article 120 placed in the article holding device 118 in accordance with an embodiment of the present invention.

As shown, an article 120 is placed in the article holding device 118. In an embodiment, at least one surface of the article 120 is in contact with one or more cooling devices 108. In an embodiment, the one or more articles 120 placed in the article holding device 118 may not be in direct contact with the one or more cooling devices 108 but are placed close enough to the cooling devices 108 for optimal cooling.

FIG. 7 illustrates a perspective view of a straddle type vehicle 200 having a storage compartment, in accordance with the embodiments of the present invention.

The straddle type vehicle 200 has a seat 202 on which an occupant sits. Arrows provided in the top left corner depicts direction with respect to the vehicle, wherein an arrow F denotes front direction, an arrow R indicates rear direction, an arrow Up denotes upward direction, an arrow Dw denotes downward direction.

A storage compartment (not shown) having the same features as the storage compartment 100 is disposed beneath the seat 202. The storage compartment in the straddle type vehicle 200 has a base 102 and a plurality of walls 104 extending from the base 102 in a vehicle upward direction to define a storge space 107. The storage compartment 100 is covered by the seat 202 of the straddle type vehicle 200. The storage compartment 100 disposed beneath the seat 202 has the same features as disclosed in FIGS. 1-6 of the present invention which have already been discussed in the preceding paragraphs and are not repeated again to avoid redundancy.

Advantageously, the present invention provides one or more cooling devices 108 on the walls 104 of the storage compartment 100. Therefore, the one or more cooling devices 108 take minimum space in the storage compartment 100. This is particularly advantageous for storge compartments which are small or congested. In a non-limiting example, in a straddle type vehicle 200, the storage compartment 100 disposed beneath the seat 202 stores helmets for both the rider as well as pillion rider which makes the storage space congested. The use of cooling devices 108 on the walls 104 of the storage compartments, therefore, saves considerable space.

Another advantageous effect of using the one or more cooling devices 108 in the storage compartments 100 is that the temperature sensitive articles can be safely stored in such compartments 100. The temperature sensitive articles are perishable items, food items, electronic items, and the likes.

Another advantageous effect of the present invention is that cooling devices 108 can be operated in various modes such as vehicle running condition and/or vehicle non-running condition. In a non-limiting example, performance of the vehicle is not compromised as the cooling can be activated only when the vehicle is running.

While the present invention has been described with respect to certain embodiments, it will be apparent to those skilled in the art that various changes and modification may be made without departing from the scope of the invention as defined in the following claims.

### REFERENCE NUMERALS

100—Storage compartment
102—Base
104—walls
104a—primary walls
104b—secondary walls
106a—inner surface of the walls
106b—outer surface of the walls
107—Storage Space
108—cooling device
110a—first cut out portions
110b—second cut out portions
112—wiring harness of the cooling device
114—front plate of the cooling device
116—rear plate of the cooling device
118—article holding device
118a—body portion of the article holding device
118b—ends of the article holding device
120—article
122—primary storage compartment
124—secondary storage compartment
200—straddle type vehicle
202—seat

1-25. (canceled)

26. A storage compartment for a vehicle, the storage compartment comprising:
a base;
a plurality of walls extending from the base to define a storage space; and
at least one cooling device disposed inside the storage space, wherein
at least one of the walls is configured to receive the at least one cooling device.

27. The storage compartment as claimed in claim 26, wherein the storage space is covered by a lid.

28. The storage compartment as claimed in claim 26, wherein the at least one of the walls has one or more first cut out portions to receive a wiring harness of the at least one cooling device.

29. The storage compartment as claimed in claim 26, wherein
the at least one cooling device comprises at least one front plate and at least one rear plate positioned opposite the front plate, and
the at least one rear plate is a hot plate and faces the at least one of the walls.

30. The storage compartment as claimed in claim 29, wherein
the at least one of the walls has one or more second cut out portions to dissipate the heat of the at least one rear plate into environment, and
the at least one rear plate is operatively connected to one or more heat exchangers.

31. The storage compartment as claimed in claim 29, further comprising:
an article holding device connected to at least one of the walls such that at least one surface of an article stored in the article holding device is in contact with the front plate of the at least one cooling device, wherein
the front plate of the at least one cooling device is a cold plate and faces the storage space.

32. The storage compartment as claimed in claim 26, further comprising:
a primary storage compartment; and
a secondary storage compartment, wherein
the secondary storage compartment has at least one cooling device.

33. The storage compartment as claimed in claim 26, wherein
the at least one cooling device is switched ON when the vehicle is running and switched OFF when the vehicle is not running, and
the at least one cooling device is connected to an ignition key unit and capable of being switched ON when the vehicle is not running.

34. The storage compartment as claimed in claim 26, further comprising:
a weight sensor disposed inside the storage space and in communication with the at least one cooling device; wherein
the weight sensor is configured to detect weight of the article stored inside the storage compartment, and
the cooling device is capable of being switched ON when weight detected by the weight sensor exceeds a predetermined weight.

35. A straddle type vehicle comprising:
a seat on which an occupant sits;
an article storage compartment positioned beneath the seat, the article storage compartment having a base and walls extending from the base in a vehicle upward direction to define a storage space; and
at least one cooling device disposed inside the storage space, wherein
at least one of the walls is configured to receive the at least one cooling device.

36. The straddle type vehicle as claimed in claim 35, wherein
the at least one of the walls has one or more first cut out portions to receive a wiring harness of the at least one cooling device,
the at least one cooling device comprises at least one front plate and at least one rear plate positioned opposite to the front plate,
the at least one rear plate is a hot plate and faces the at least one of the walls, and
the front plate is a cold plate and faces the storage space.

37. The straddle type vehicle as claimed in claim 36, wherein
the at least one of the walls has one or more second cut out portions to dissipate the heat of the at least one rear plate into environment, and
the at least one rear plate of the at least one cooling device is operatively connected to one or more heat exchangers.

38. The straddle type vehicle as claimed in claim 37, further comprising:
an article holding device connected to at least one of the walls such that at least one surface of an article stored in the article holding device is in contact with the front plate of the at least one cooling device.

39. The straddle type vehicle as claimed in claim 35, wherein
the storage compartment comprises a primary storage compartment and a secondary storage compartment having at least one cooling device,
the at least one cooling device is switched ON when the vehicle is running and switched OFF when the vehicle is not running, and
the at least one cooling device is connected to an ignition key unit and capable of being switched ON when the vehicle is not running.

40. The straddle type vehicle as claimed in claim 35, further comprising:
a weight sensor disposed inside the storage space and in communication with the at least one cooling device, wherein
the weight sensor is configured to detect weight of the article stored inside the storage compartment, and
the cooling device is capable of being switched ON when weight detected by the weight sensor exceeds a predetermined weight.
